(19) United States
(12) Patent Application Publication
(10) Pub. No.: US 2025/0381618 A1
(43) Pub. Date: Dec. 18, 2025

(54) LASER PROCESSING APPARATUS

(71) Applicant: DISCO CORPORATION, Tokyo (JP)

(72) Inventors: Kazuki MORI, Tokyo (JP); Nobuki KAKIUCHI, Tokyo (JP)

(21) Appl. No.: 19/204,923

(22) Filed: May 12, 2025

(30) Foreign Application Priority Data
Jun. 14, 2024 (JP) 2024-096529

(51) Int. Cl. B23K 26/08

(52) U.S. Cl. CPC B23K 26/0876

(57) ABSTRACT

A laser processing apparatus includes a holding unit, a laser beam irradiating unit, a processing feed unit, a first resistance measuring apparatus including a first measurement head, and a controller, the controller being configured to, when irradiating a workpiece with a laser beam while moving the holding unit and a condenser relative to each other along a processing feed direction, measure electric resistance or electric resistivity of a measurement target region of the workpiece by using the first measurement head and maintain or change a condition for processing the workpiece by the laser beam to be applied to the measurement target region according to the electric resistance or the electric resistivity of the measurement target region.

### BACKGROUND OF THE INVENTION

### Field of the Invention

The present invention relates to a laser processing apparatus for processing a workpiece by a laser beam, a laser processing method for processing a workpiece by a laser beam, and a program for making a computer mounted in a laser processing apparatus perform a laser beam irradiating step.

### Description of the Related Art

A technology has been proposed which forms a separating layer reduced in mechanical strength at a predetermined depth from one surface of a silicon carbide (SiC) ingot by using a pulsed laser beam having a wavelength passing through the SiC ingot, and separates a SiC wafer from the SiC ingot with the separating layer as a starting point (see Japanese Patent Laid-Open No. 2016-111143, for example).

A compound semiconductor such as SiC may be doped with an impurity in order to impart conductivity to the compound semiconductor. For example, in order to make the SiC ingot an n-type, the SiC ingot is doped with a donor such as nitrogen (N) or phosphorus (P), or in order to make the SiC ingot a p-type, the SiC ingot is doped with an acceptor such as boron (B) or aluminum (Al).

Now, there may be variation in electric resistivity between a plurality of SiC ingots. In an n-type SiC ingot, the higher the impurity concentration of nitrogen, the lower the electric resistivity, and the higher the impurity concentration of nitrogen, the higher the absorptivity of a laser beam. Therefore, in a case of forming the above-described separating layer by multiphoton absorption that occurs at a condensing point of the laser beam passing through the SiC ingot when the condensing point is positioned within the SiC ingot, the separating layer may not be formed appropriately when same laser processing conditions are always applied to any of the plurality of SiC ingots.

Accordingly, a proposition has been made to apply the laser processing conditions adjusted according to the electric resistivity of the SiC ingot after measuring the electric resistivity of the SiC ingot in advance by using resistance value measuring means before laser processing (see Japanese Patent Laid-Open No. 2021-106186, for example). However, at a time of crystal growth of the SiC ingot, the distribution of impurity concentration within the SiC ingot does not necessarily become uniform.

A SiC single crystal is, for example, obtained by growing the crystal mainly along a c-axis (that is, <0001>) on a c-plane (that is, (0001)) of a seed crystal. However, at a time of the crystal growth, an amount of nitrogen captured in facets corresponding to {0001} tends to be large as compared with other regions. Incidentally, in the present specification, a region in which crystal growth has progressed on a facet corresponding to {0001} will be referred to as a facet region, and a region other than the facet region in the SiC ingot will be referred to as a non-facet region.

In the SiC ingot, the impurity concentration of the facet region is higher than the impurity concentration of the other region. In an example, the facet region having a relatively high impurity concentration is formed in a central portion of the SiC ingot, and the non-facet region having a relatively low impurity concentration is formed in a peripheral portion of the SiC ingot so as to surround the facet region.

Because the facet region has a higher impurity concentration than the non-facet region, the absorptivity of the laser beam in the facet region is higher than the absorptivity of the laser beam in the non-facet region. That is, in the facet region, the transmissivity of the laser beam for the SiC ingot is lower than in the non-facet region.

Therefore, in a case where both of the facet region and the non-facet region are subjected to laser processing under predetermined laser processing conditions, for example, excellent laser processing is realized in the non-facet region, whereas in the facet region, the energy of the laser beam per unit area does not reach a processing threshold value, so that a processing defect may occur.

Now, the impurity concentration in the SiC ingot is in negative correlation to the number of photons of fluorescence emitted by the SiC ingot by absorbing excitation light applied thereto. Specifically, the higher the impurity concentration is, the smaller the number of photons of the fluorescence tends to be. Accordingly, a proposition has been made to change the laser processing conditions on the basis of the number of photons of the fluorescence in each of a plurality of regions in an exposed surface of one SiC ingot (see Japanese Patent Laid-Open No. 2022-127088, for example).

However, in a case of performing a fluorescence detecting step in which a distribution of occurrence of the fluorescence is investigated by irradiating the whole of an exposed surface of a workpiece such as the SiC ingot with excitation light before a laser processing step, the number of man-hours is increased by an amount corresponding to the fluorescence detecting step, and throughput is consequently decreased, as compared with ordinary laser processing in which the fluorescence detecting step is not performed. Also in a case of performing a resistance measuring step of measuring the electric resistivity on the whole of the exposed surface of the workpiece by using the resistance value measuring means as described earlier, the number of man-hours is increased by an amount corresponding to the resistance measuring step, and throughput is consequently decreased, as compared with ordinary laser processing in which the resistance measuring step is not performed.

### SUMMARY OF THE INVENTION

The present invention has been made in view of such problems. It is an object of the present invention to improve the throughput of laser processing as compared with related art in a case of making laser processing conditions adjustable according to the impurity concentration of each region of the exposed surface of a workpiece, and performing the laser processing.

In accordance with an aspect of the present invention, there is provided a laser processing apparatus for processing a workpiece by a laser beam. The laser processing apparatus includes a holding unit configured to hold the workpiece, a laser beam irradiating unit including a laser oscillator configured to emit the laser beam and a condenser including a condensing lens configured to condense the laser beam emitted from the laser oscillator, a processing feed unit including a first motor and configured to move the holding unit and the condenser relative to each other along a processing feed direction, a first resistance measuring apparatus including a first measurement head having a fixed relative position with respect to the condenser and configured to be relatively movable by the processing feed unit along the processing feed direction with respect to the holding unit together with the condenser, the first resistance measuring apparatus being configured to measure electric resistance or electric resistivity of the workpiece via the first measurement head, and a controller including a processor and a memory and configured to control the laser beam irradiating unit and the processing feed unit, the controller being configured to, when irradiating the workpiece with the laser beam while moving the holding unit and the condenser relative to each other along the processing feed direction, measure the electric resistance or the electric resistivity of a measurement target region of the workpiece by using the first measurement head and maintain or change a condition for processing the workpiece by the laser beam to be applied to the measurement target region according to the electric resistance or the electric resistivity of the measurement target region.

Preferably, the laser processing apparatus further includes a second resistance measuring apparatus including a second measurement head having a fixed relative position with respect to the condenser and the first measurement head and configured to be relatively movable by the processing feed unit along the processing feed direction with respect to the holding unit together with the condenser, the second resistance measuring apparatus being configured to measure the electric resistance or the electric resistivity of the workpiece via the second measurement head, in which the first measurement head and the second measurement head are arranged so as to sandwich the condenser in the processing feed direction.

Preferably, when irradiating the workpiece with the laser beam while moving the holding unit and the condenser relative to each other along the processing feed direction, the controller measures the electric resistance or the electric resistivity by using one of the first measurement head and the second measurement head that precedes the condenser in the processing feed direction.

Preferably, the laser processing apparatus further includes an indexing feed unit including a second motor and configured to move the holding unit and the condenser relative to each other along an indexing feed direction intersecting the processing feed direction, in which the controller moves the holding unit and the condenser relative to each other so as to sequentially repeat, when processing the workpiece by the laser beam, a first processing feed configured to move the holding unit and the condenser relative to each other such that the first measurement head precedes the condenser in the processing feed direction, a first indexing feed configured to move the holding unit and the condenser relative to each other in the indexing feed direction, a second processing feed configured to move the holding unit and the condenser relative to each other such that the second measurement head precedes the condenser in the processing feed direction, and a second indexing feed configured to move the holding unit and the condenser relative to each other in the indexing feed direction.

In accordance with another aspect of the present invention, there is provided a laser processing method for processing a workpiece by a laser beam. The laser processing method includes holding the workpiece by a holding unit, and when irradiating the workpiece with the laser beam while moving the holding unit and a condenser relative to each other along a processing feed direction, measuring electric resistance or electric resistivity of a measurement target region of the workpiece by using a first measurement head having a fixed relative position with respect to the condenser, and maintaining or changing a condition for processing the workpiece by the laser beam to be applied to the measurement target region according to the electric resistance or the electric resistivity of the measurement target region.

In accordance with a further aspect of the present invention, there is provided a program for making a computer mounted in a laser processing apparatus perform a laser beam irradiating step of, when irradiating a workpiece with a laser beam while moving a holding unit holding the workpiece and a condenser relative to each other along a processing feed direction, measuring electric resistance or electric resistivity of a measurement target region of the workpiece by using a first measurement head having a fixed relative position with respect to the condenser, and maintaining or changing a condition for processing the workpiece by the laser beam to be applied to the measurement target region according to the electric resistance or the electric resistivity of the measurement target region.

In accordance with a still further aspect of the present invention, there is provided a laser processing apparatus for processing a workpiece by a laser beam. The laser processing apparatus includes a holding unit configured to hold the workpiece, a laser beam irradiating unit including a laser oscillator configured to emit the laser beam and a condenser including a condensing lens configured to condense the laser beam emitted from the laser oscillator; a processing feed unit including a first motor and configured to move the holding unit and the condenser relative to each other along a processing feed direction, a fluorescence measuring apparatus including a measurement head having a fixed relative position with respect to the condenser and configured to be relatively movable by the processing feed unit along the processing feed direction with respect to the holding unit together with the condenser, the measurement head including an excitation light source, a condensing lens configured to condense excitation light from the excitation light source to the workpiece, and an optical sensor configured to receive fluorescence emitted from the workpiece when the workpiece absorbs the excitation light, and a controller including a processor and a memory and configured to control the laser beam irradiating unit and the processing feed unit, the controller being configured to, when irradiating the workpiece with the laser beam while moving the holding unit and the condenser relative to each other along the processing feed direction, maintain or change a condition for processing the workpiece by the laser beam to be applied to a measurement target region of the workpiece according to the number of photons of the fluorescence from the measurement target region, the number being obtained by using the measurement head.

In laser processing according to one aspect of the present invention, when the workpiece is irradiated with the laser beam, the electric resistance or electric resistivity of the measurement target region of the workpiece is measured by using the first measurement head, and the condition for processing the workpiece by the laser beam to be applied to the measurement target region is maintained or changed according to the measured electric resistance or the measured electric resistivity of the measurement target region.

Therefore, the measurement of the electric resistance or the electric resistivity in the workpiece and the laser processing on the workpiece according to the electric resistance or the electric resistivity can be performed temporally in parallel with each other. That is, an investigation for the laser processing condition and the laser processing reflecting a result of the investigation can be performed in one processing feed operation. Hence, it is possible to reduce the number of man-hours as compared with a case of starting the laser processing after ending the measurement of the electric resistance or the electric resistivity in regions corresponding to the movement trajectory of the condensing point of the laser beam on an exposed surface of the workpiece. That is, the throughput of the laser processing can be improved.

In laser processing according to another aspect of the present invention, when the workpiece is irradiated with the laser beam, the condition for processing the workpiece by the laser beam to be applied to the measurement target region is maintained or changed according to the number of photons of the fluorescence from the measurement target region of the workpiece, the number being obtained by using the measurement head.

Therefore, the measurement of the number of photons of the fluorescence in the workpiece and the laser processing on the workpiece according to the number of photons of the fluorescence can be performed temporally in parallel with each other. That is, an investigation for the laser processing condition and the laser processing reflecting a result of the investigation can be performed in one processing feed operation. Hence, it is possible to reduce the number of man-hours as compared with a case of starting the laser processing after ending the measurement of the number of photons of the fluorescence in regions corresponding to the movement trajectory of the condensing point on the exposed surface of the workpiece. That is, the throughput of the laser processing can be improved.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser processing apparatus;

FIG. 2A is a side view of an ingot;

FIG. 2B is a plan view of the ingot;

FIG. 3 is a schematic diagram of a laser beam irradiating unit;

FIG. 4 is a block diagram of principal parts of the laser processing apparatus;

FIG. 5 is a flowchart of a laser processing method;

FIG. 6 is a plan view of the ingot, the plan view illustrating a first processing feed, a first indexing feed, a second processing feed, and a second indexing feed;

FIG. 7A is a schematic diagram illustrating a measurement of electric resistivity and laser processing at time t₁;

FIG. 7B is a schematic diagram illustrating the measurement of the electric resistivity and the laser processing at time t₂;

FIG. 7C is a schematic diagram illustrating the measurement of the electric resistivity and the laser processing at time t₃;

FIG. 8 is a graph illustrating correspondence relation between the electric resistivity and pulse energy;

FIG. 9 is a block diagram illustrating principal parts of a laser processing apparatus in a first modification;

FIG. 10 is a block diagram illustrating principal parts of a laser processing apparatus in a second embodiment;

FIG. 11 is a partially sectional side view illustrating a first measurement head in the second embodiment;

FIG. 12A is a plan view illustrating positional relation between a condenser, a first measurement head, and a second measurement head in a second modification;

FIG. 12B is a diagram illustrating which of results of measurements using the first measurement head and the second measurement head a controller stores; and

FIG. 12C is a diagram illustrating a movement range of a first measurement head in a foregoing embodiment in comparison with the second modification.

### DETAILED DESCRIPTION OF THE PREFERRED EMBODIMENTS

### First Embodiment

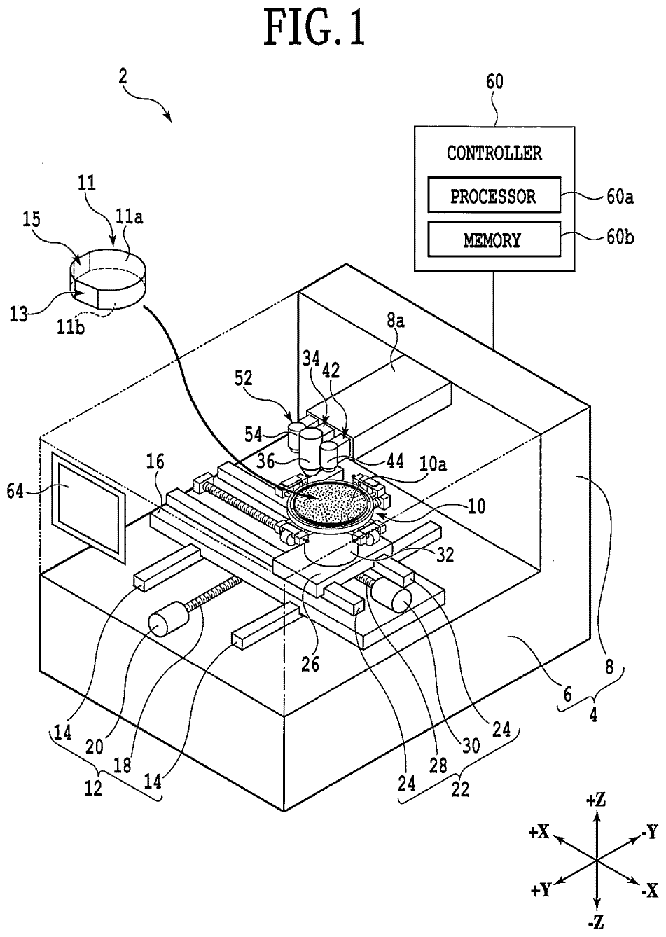

An embodiment according to one aspect of the present invention will be described with reference to the accompanying drawings. FIG. 1 is a perspective view of a laser processing apparatus 2. In FIG. 1, a part of constituent elements of the laser processing apparatus 2 are represented by functional blocks. In addition, an X-axis, a Y-axis, and a Z-axis each illustrated in FIG. 1 are orthogonal to each other. A +X direction and a −X direction are parallel with the X-axis, but are opposite directions from each other. Similarly, a +Y direction and a −Y direction are parallel with the Y-axis, but are opposite directions from each other. In addition, a +Z direction and a −Z direction are parallel with the Z-axis, but are opposite directions from each other.

In the present specification, the +X direction and the −X direction may be referred to collectively as an X-axis direction. Similarly, the +Y direction and the −Y direction may be referred to collectively as a Y-axis direction, and the +Z direction and the −Z direction may be referred to collectively as a Z-axis direction. Incidentally, the X-axis is parallel with a processing feed direction (that is, the +X direction and the −X direction), the Y-axis is parallel with an indexing feed direction (that is, the +Y direction and the −Y direction), and the Z-axis is parallel with a vertical direction (that is, an upward-downward direction).

The laser processing apparatus 2 includes a base 4 that supports various constituent elements. The base 4 includes a flat plate portion 6 in a rectangular parallelepipedic shape and a wall portion 8 that extends upward at one end of the flat plate portion 6. A chuck table (holding unit) 10 in a disk shape is provided above the flat plate portion 6.

The chuck table 10 has a frame body in a disk shape. A recessed portion in a disk shape is provided to a radially central portion of the frame body. A porous plate having an outside diameter that is substantially the same diameter as that of the recessed portion is fixed to the recessed portion. The upper surface of the frame body and the upper surface of the porous plate are substantially flush with each other, and constitute a substantially flat holding surface 10a. The holding surface 10a is disposed so as to be substantially parallel with an XY plane.

The laser processing apparatus 2 is provided with a vacuum generating apparatus (not illustrated) such as a vacuum pump or an ejector. A negative pressure is transmitted from the vacuum generating apparatus to the porous plate via a predetermined flow passage (not illustrated). Due to this negative pressure, an ingot (workpiece) 11 is sucked and held by the holding surface 10a.

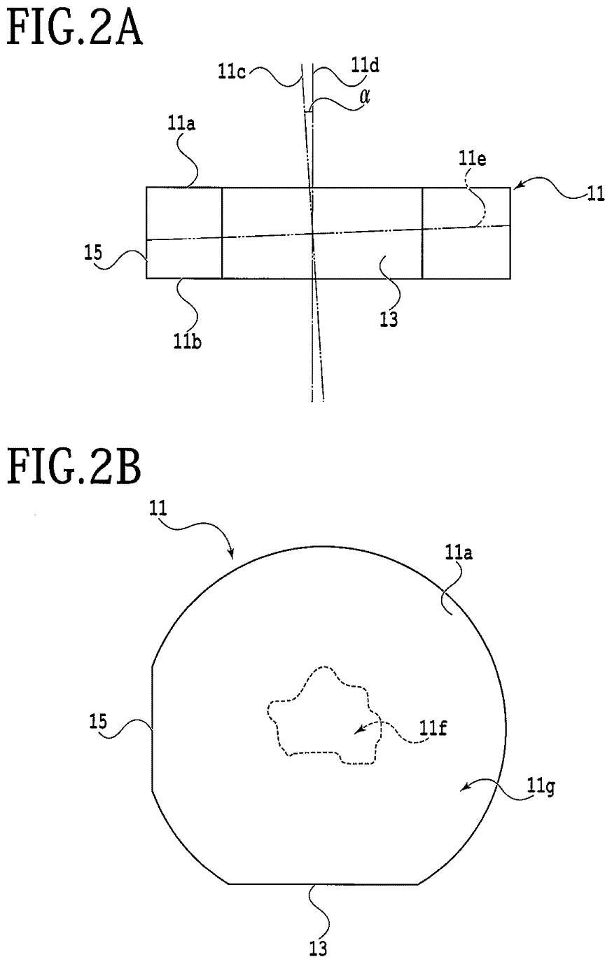

FIG. 2A is a side view of the ingot 11. FIG. 2B is a plan view of the ingot 11. The ingot 11 in the present embodiment is a SiC ingot in a cylindrical shape, and has a diameter of 8 inches (approximately 200 mm) and a thickness of approximately 20 mm. However, the material of the ingot 11 is not limited to SiC but may be another material such as gallium nitride (GaN), Ga₂O₃ (gallium oxide), or LiTaO₃ (lithium tantalate). In addition, the shape of the ingot 11 is not limited to the cylindrical shape, but may be another shape such as a flat plate shape or a rectangular parallelepipedic shape.

The ingot 11 has one surface 11a and another surface 11b that are substantially flat. As illustrated in FIG. 2A, in the ingot 11, a c-axis 11c of a single crystal SiC is slightly inclined with respect to a normal 11d that is orthogonal to the one surface 11a and the another surface 11b.

In FIG. 2A, the c-axis 11c is indicated by a chain double-dashed line, and the normal 11d is indicated by alternate long and short dashed lines. The c-axis 11c is orthogonal to a c-plane lie. Incidentally, for the convenience of description, FIG. 2A illustrates one specific c-plane lie. An angle (that is, an off angle) a formed between the c-axis 11c and the normal 11d is equal to or more than 1° and equal to or less than 6° (typically 4°).

The ingot 11 has a primary orientation flat 13 and a secondary orientation flat 15 on a peripheral side surface thereof. In the one surface 11a and the another surface 11b, the primary orientation flat 13 is longer than the secondary orientation flat 15. However, the orientation flats are not essential, but notches may be provided in place of the orientation flats.

The ingot 11 in the present embodiment is doped with a donor such as nitrogen. The ingot 11 includes the above-described facet region 11f and the above-described non-facet region 11g as a region other than the facet region 11f. The impurity concentration of the facet region 11f is higher than the impurity concentration of the non-facet region 11g.

The facet region 11f in the present embodiment is a columnar region formed from the one surface 11a to the another surface 11b along the c-axis 11c. In addition, the non-facet region 11g is formed so as to surround the facet region 11f. Incidentally, while a boundary between the facet region 11f and the non-facet region 11g is illustrated in FIG. 2B for the convenience of description, such a boundary in an actual ingot 11 may not be able to be visually recognized by visible light.

Returning to FIG. 1, other constituent elements of the laser processing apparatus 2 will be described. An indexing feed unit 12 that moves the chuck table 10 along the Y-axis is provided below the chuck table 10. The indexing feed unit 12 has a pair of guide rails 14.

The pair of guide rails 14 is fixed to the upper surface of the flat plate portion 6, and is disposed so as to be substantially parallel with the Y-axis. A moving table 16 is slidably attached to the pair of guide rails 14. A nut portion (not illustrated) is provided to the lower surface of the moving table 16.

A threaded shaft 18 disposed so as to be substantially parallel with the Y-axis is rotatably coupled to this nut portion via a plurality of balls (not illustrated). A motor (second motor) 20 such as a servomotor or a stepping motor is coupled to one end of the threaded shaft 18.

When the threaded shaft 18 is rotated by the motor 20, the moving table 16 moves along the Y-axis. A processing feed unit 22 is provided to the upper surface of the moving table 16. The processing feed unit 22 has a pair of guide rails 24.

The pair of guide rails 24 is fixed to the upper surface of the moving table 16, and is disposed so as to be substantially parallel with the X-axis. A moving table 26 is slidably attached to the pair of guide rails 24. A nut portion (not illustrated) is provided to the lower surface of the moving table 26.

A threaded shaft 28 disposed so as to be substantially parallel with the X-axis is rotatably coupled to this nut portion via a plurality of balls (not illustrated). A motor (first motor) 30 such as a servomotor or a stepping motor is coupled to one end of the threaded shaft 28.

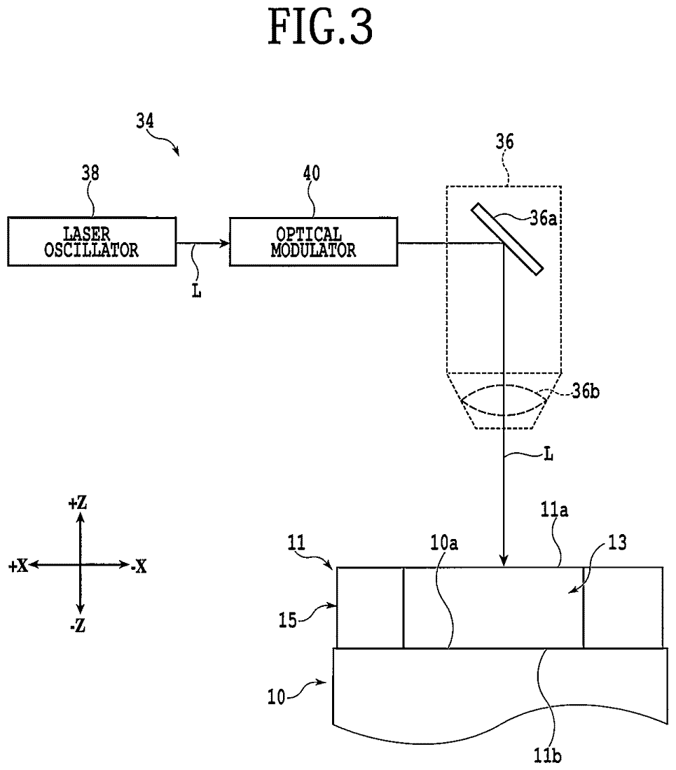

When the threaded shaft 28 is rotated by the motor 30, the moving table 26 moves along the X-axis. An adjustment of the movement speed of the moving table 26 can adjust intervals between pulses adjacent to each other (that is, a pulse pitch) in the X-axis direction when the ingot 11 is irradiated with a pulsed laser beam L (see FIG. 3) to be described later.

A support base 32 in a cylindrical shape is provided to the upper surface of the moving table 26. The chuck table 10 described above is provided to a top portion of the support base 32. A rotational driving source (not illustrated) such as a motor is provided within the support base 32.

A rotary shaft of the chuck table 10 corresponds to an output shaft of the rotational driving source or is coupled to the output shaft. The longitudinal direction of the rotary shaft of the chuck table 10 is disposed so as to be substantially parallel with the Z-axis. When the rotational driving source is operated, the chuck table 10 rotates about the rotary shaft.

A support arm 8a in a beam shape is provided above the chuck table 10. A distal end portion of the support arm 8a is provided with a condenser 36 of a laser beam irradiating unit 34. The laser beam irradiating unit 34 includes a laser oscillator 38 (see FIG. 3) fixed to the base 4.

FIG. 3 is a schematic diagram of the laser beam irradiating unit 34. Incidentally, in FIG. 3, a part of constituent elements of the laser beam irradiating unit 34 are represented by functional blocks. The laser oscillator 38 includes a laser medium. The laser medium is, for example, a crystal such as Nd:YAG.

When the laser medium is irradiated with excitation light from a light source such as a flash lamp or a laser diode, the laser oscillator 38 emits the pulsed laser beam L having a wavelength (for example, 1064 nm) that passes through the ingot 11.

The laser beam L emitted from the laser oscillator 38 enters an optical modulator 40. The optical modulator 40 can adjust the power (that is, an average power, a peak power, or the like) of the laser beam L according to an electric signal input to the optical modulator 40, and controls whether or not to irradiate the condenser 36 with the laser beam L.

The optical modulator 40 is, for example, an acousto-optic modulator (AOM), an electro-optic modulator (EOM), or a liquid crystal on silicon-spatial light modulator (LCOS-SLM).

The AOM, the EOM, the LCOS-SLM, or the like is controlled by an electric signal from a controller 60 to be described later, and can therefore operate at a higher response speed than an attenuator. The attenuator includes a half-wave plate and a polarization beam splitter where the half-wave plate is physically rotated with respect to the polarization beam splitter.

The repetition frequency of the laser beam L can also be controlled by controlling the operation of the AOM and the EOM in the controller 60. An adjustment of the repetition frequency of the laser beam L can adjust the pulse pitch of the laser beam L in the X-axis direction when the moving table 26 is moved at a fixed speed along the X-axis.

Incidentally, the pulse pitch of the laser beam L in the X-axis direction may be adjusted by adjusting one or both of the speed of movement along the X-axis direction of the moving table 26 and the repetition frequency of the laser beam L.

The laser beam L passed through the optical modulator 40 travels to the condenser 36. A mirror 36a and a condensing lens 36b are provided within the condenser 36. The laser beam L reflected by the mirror 36a is applied, in a state of being condensed by the condensing lens 36b, to the holding surface 10a.

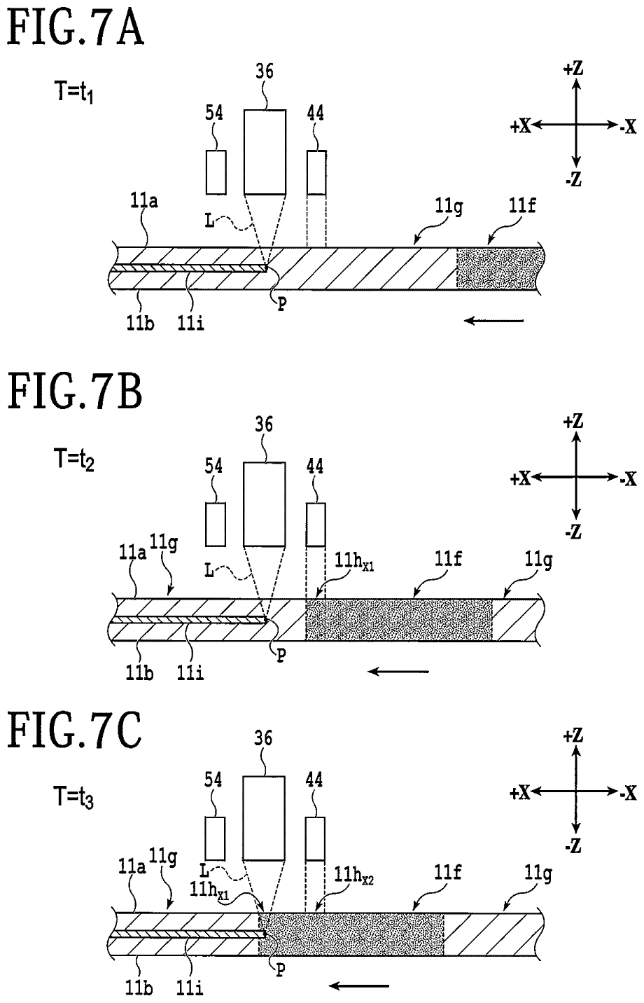

The condensing lens 36b is configured to be movable along the Z-axis by a piezoelectric actuator (not illustrated) including a piezoelectric element. A movement of the condensing lens 36b along the Z-axis can move the position of a condensing point P (see FIG. 7A) of the laser beam L along the Z-axis.

A movement of the position of the condensing point P along the Z-axis can adjust the power of the laser beam L with which the ingot 11 is irradiated when a separating layer 11i (see FIG. 7A) is formed at a predetermined depth position within the ingot 11.

Returning to FIG. 1 again, a description will be made of other constituent elements of the laser processing apparatus 2. A first measurement head 44 that constitutes a first resistance measuring apparatus 42 is fixed at a position that is on the distal end portion of the support arm 8a and which is adjacent in the −X direction to the condenser 36.

That is, the first measurement head 44 has a fixed spatial relative position with respect to the condenser 36. However, the first measurement head 44 is configured to be relatively movable with respect to the chuck table 10 along the processing feed direction.

Specifically, when the chuck table 10 and the condenser 36 are moved relative to each other along the processing feed direction by using the processing feed unit 22, the first measurement head 44 relatively moves with respect to the chuck table 10 along the processing feed direction together with the condenser 36.

Incidentally, when the chuck table 10 and the condenser 36 are moved relative to each other along the indexing feed direction by using the indexing feed unit 12, the first measurement head 44 relatively moves with respect to the chuck table 10 along the indexing feed direction together with the condenser 36.

A second measurement head 54 that constitutes a second resistance measuring apparatus 52 is fixed at a position that is on the distal end portion of the support arm 8a and which is adjacent in the +X direction to the condenser 36. The second measurement head 54 also has a fixed spatial relative position with respect to the condenser 36.

The first measurement head 44 and the second measurement head 54 are arranged so as to sandwich the condenser 36 in the processing feed direction. In a case where the processing feed direction (that is, a movement direction of the condensing point P of the laser beam L) is the −X direction, the first measurement head 44 precedes the condenser 36 in the processing feed direction. In a case where the processing feed direction is the +X direction, the second measurement head 54 precedes the condenser 36 in the processing feed direction.

The second measurement head 54 is also configured to be relatively movable with respect to the chuck table 10 along the processing feed direction. Specifically, when the chuck table 10 and the condenser 36 are moved relative to each other along the processing feed direction by using the processing feed unit 22, as with the first measurement head 44, the second measurement head 54 also relatively moves with respect to the chuck table 10 along the processing feed direction together with the condenser 36.

In addition, when the chuck table 10 and the condenser 36 are moved relative to each other along the indexing feed direction by using the indexing feed unit 12, as with the first measurement head 44, the second measurement head 54 also relatively moves with respect to the chuck table 10 along the indexing feed direction together with the condenser 36. The indexing feed direction is the −Y direction, for example, but may be the +Y direction.

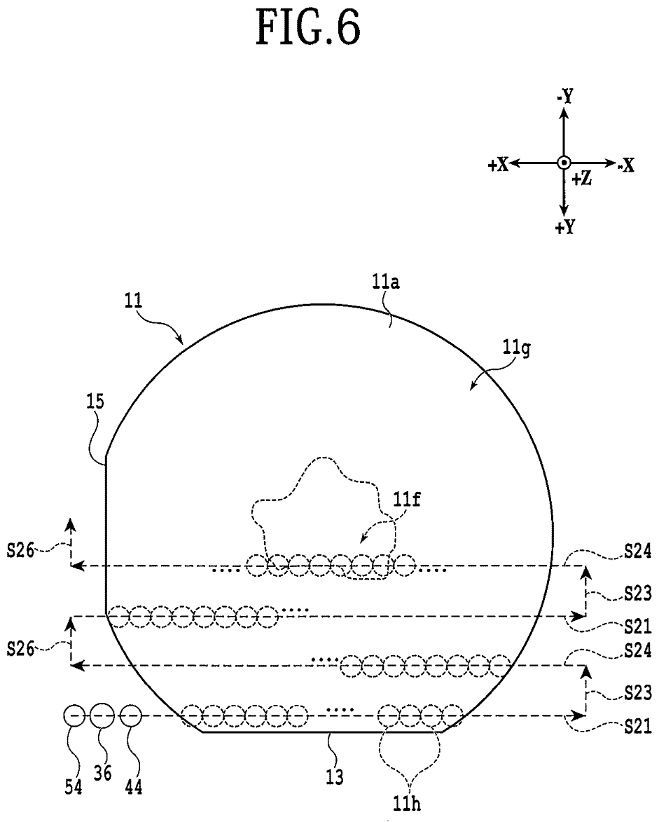

The first resistance measuring apparatus 42 and the second resistance measuring apparatus 52 measure electric resistance or electric resistivity in a local region (corresponding to a measurement target region 11h (see FIG. 6) to be described later) of the one surface 11a by using an eddy current generated in a local region (for example, a circular region having a diameter of approximately 5.0 mm to 10 mm) of the one surface 11a.

Usable as the first resistance measuring apparatus 42 and the second resistance measuring apparatus 52 is, for example, EC-80P, which is a noncontact type resistance measuring apparatus that is manufactured and sold by Napson Corporation.

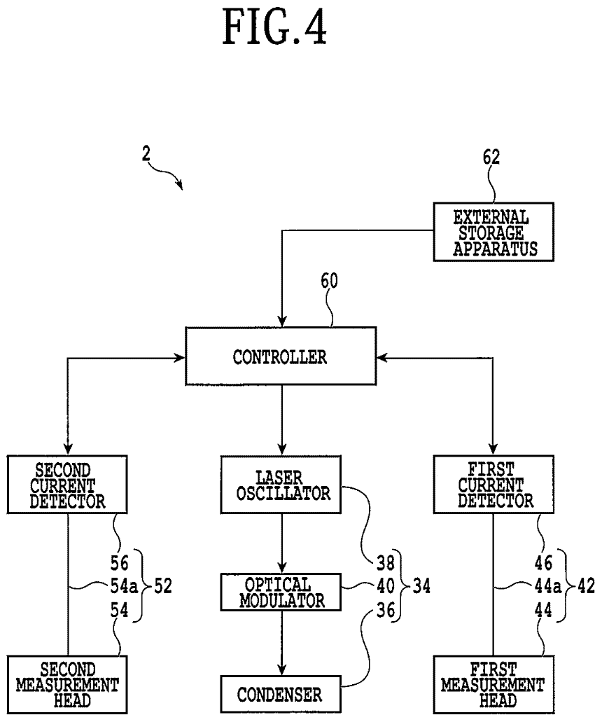

FIG. 4 is a block diagram of principal parts of the laser processing apparatus 2. An outline of the first resistance measuring apparatus 42 will first be described. The first measurement head 44 includes a magnetic core (not illustrated) formed of a material such as a Mn—Zn-based ferrite. The magnetic core is wound with an exciting coil 44a.

When a high frequency voltage of approximately 0.4 MHz to 10 MHz is applied to the exciting coil 44a in a state in which a lower end portion of the magnetic core is disposed in proximity to the one surface 11a, a magnetic field that temporally changes occurs in the magnetic core, and therefore an eddy current occurs in the one surface 11a of the ingot 11. A current flowing through the exciting coil 44a thereby changes.

The change in the current flowing through the exciting coil 44a is detected by a first current detector 46. The first current detector 46 may be of a resistance detection type having a shunt resistance through which a current flows, or may be of a magnetic field detection type that measures the change in the current by using the magnetic field.

The first current detector 46 further includes a computer that includes a processor typified by a central processing unit (CPU), a main storage apparatus such as a dynamic random access memory (DRAM), and an auxiliary storage apparatus such as a flash memory.

The auxiliary storage apparatus stores software including a predetermined program. Functions of the first current detector 46 are implemented by operating the processor and the like according to the software. It is to be noted that there is no limitation to the processor, but a field-programmable gate array (FPGA), an application specific integrated circuit (ASIC), or the like may be used.

The first current detector 46 converts the change in the current flowing through the exciting coil 44a into the electric resistance (that is, a volume resistance (Ω) or a sheet resistance (Ω/□)), the electric resistivity (Ω·cm), or the like of the circular region of the one surface 11a according to a predetermined calculation equation. Which of the electric resistance and the electric resistivity to use may be determined as appropriate according to a measurement target object.

The first current detector 46 is configured to be able to communicate by wire communication or wireless communication with the controller 60 that controls the whole of the laser processing apparatus 2. The first current detector 46 notifies information such as the calculated electric resistivity to the controller 60. The controller 60 can thereby grasp the electric resistance or the electric resistivity of the ingot 11 measured via the first measurement head 44.

The second resistance measuring apparatus 52 also includes a magnetic core, an exciting coil 54a, a second current detector 56, and the like. A configuration of the second resistance measuring apparatus 52 is similar to that of the first resistance measuring apparatus 42, and therefore details thereof will be omitted.

The second current detector 56 notifies information such as the calculated electric resistivity to the controller 60. The controller 60 can thereby grasp the electric resistance or the electric resistivity of the ingot 11 measured via the second measurement head 54.

Incidentally, a method of measuring the resistance of the ingot 11 by using a corona discharge, a resistance measuring method that uses electrostatic coupling between a measurement cable and the ingot 11, a resistance measuring method that uses an eddy current generated by applying a pulse voltage to the ingot 11, or the like may be used in place of the resistance measuring method that uses an eddy current generated in the ingot 11 by applying a high frequency voltage as in the present embodiment.

The above-described various kinds of methods can measure the electric resistivity or the like of a local region of the ingot 11 without the first measurement head 44 and the second measurement head 54 being in contact with the ingot 11, and are therefore advantageous in that no scratch or the like is formed on the ingot 11 (one surface 11a in particular). However, the methods of measuring the electric resistivity or the like are not limited to such noncontact systems.

In place of the noncontact systems, contact systems may be applied, such as a two-terminal method that measures the electric resistivity or the like of a local region of the ingot 11 in a state in which two measurement terminals (not illustrated) are set in contact with the one surface 11a of the ingot 11 and a four-terminal method that measures the electric resistivity or the like of a local region of the ingot 11 in a state in which four measurement terminals (not illustrated) are set in contact with the one surface 11a of the ingot 11.

However, in the contact systems, in order to minimize a scratch or the like formed on the one surface 11a of the ingot 11, it is preferable to control measurement conditions such as the height position of lower ends of the measurement terminals in the Z-axis direction and a processing feed speed more precisely than in the noncontact systems.

Returning to FIG. 1 again, a description will be made of other constituent elements of the laser processing apparatus 2. The support arm 8a is also provided with a head portion of a microscope camera unit (not illustrated). The microscope camera unit includes an objective lens, a light source, and a solid-state imaging element.

The microscope camera unit, for example, images the one surface 11a by using visible light. When the rotational driving source within the support base 32 is operated on the basis of a resulting image of the one surface 11a, the orientation of the chuck table 10 is adjusted such that a predetermined direction (for example, the primary orientation flat 13) of the ingot 11 sucked and held by the holding surface 10a is substantially parallel with the X-axis (see FIG. 6).

As illustrated in FIG. 1, the base 4 is provided with a cover (not illustrated) that covers the above-described constituent elements. A side surface located on an end portion in the +Y direction of the cover is provided with a touch panel 64. The touch panel 64 is, for example, a liquid crystal display including a capacitive type touch sensor.

The touch panel 64 functions as an input apparatus for a worker to input an instruction to the laser processing apparatus 2 and as a display apparatus for displaying a graphical user interface (GUI) for inputting the instruction, the image obtained via the microscope camera unit and the like.

Incidentally, in place of the touch panel 64, a display apparatus not having the function of the input apparatus may be provided to the laser processing apparatus 2. In this case, however, an input apparatus (a keyboard, a mouse, a trackball, a touch pad, a digitizer, and the like) for the worker to input an instruction to the controller 60 is provided separately.

The laser processing apparatus 2 is provided with the controller 60 that controls the operation of the chuck table 10, the indexing feed unit 12, the processing feed unit 22, the rotational driving source within the support base 32, the laser beam irradiating unit 34, the microscope camera unit, the touch panel 64, and the like.

The controller 60 also controls the operation of the first resistance measuring apparatus 42 and the second resistance measuring apparatus 52 so as to operate one of the first measurement head 44 and the second measurement head 54 that precedes the condenser 36 in the processing feed direction.

The controller 60 is constituted by, for example, a computer including a processor 60a typified by a central processing unit (CPU) and a memory 60b. The memory 60b includes a main storage apparatus such as a dynamic random access memory (DRAM) and an auxiliary storage apparatus such as a flash memory.

The auxiliary storage apparatus stores software including a predetermined program. Functions of the controller 60 are implemented by operating the processor 60a and the like according to the software.

The predetermined program includes a program for making the controller 60 perform a laser beam irradiating step S20 to be described in the following. This program is stored in the auxiliary storage apparatus of the controller 60.

However, alternatively, this program may be stored in an external storage apparatus 62 such as a universal serial bus (USB) memory, an optical disk, a secure digital (SD) memory card, or a hard disk drive (HDD), and executed by inputting the program read via a reading apparatus to the processor 60a.

Incidentally, the external storage apparatus 62 may be read as a non-transitory tangible recording medium on which the program is recorded. A description will next be made of a laser processing method that forms a separating layer 11i within the ingot 11 by laser-processing the ingot 11 by the laser beam L.

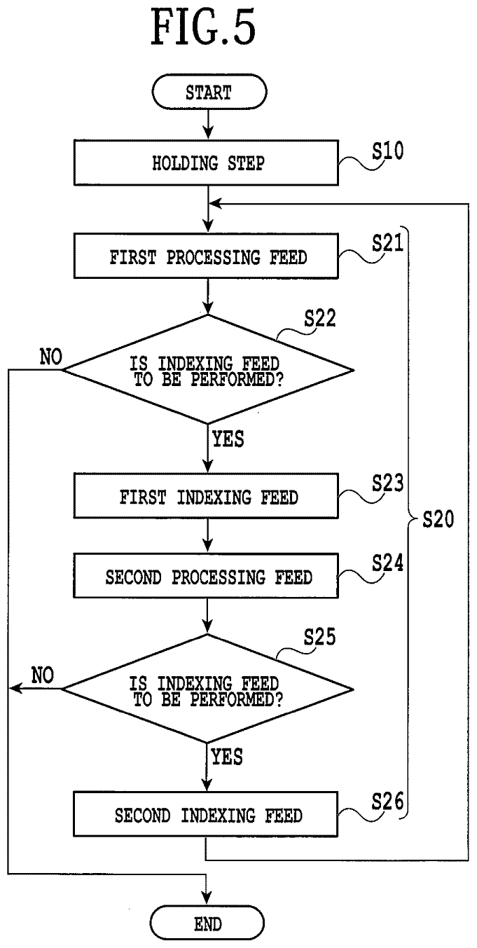

FIG. 5 is a flowchart of the laser processing method that subjects the ingot 11 to laser processing in the laser processing apparatus 2. In the present embodiment, a holding step S10 and a laser beam irradiating step S20 are performed in this order.

In the holding step S10, the holding surface 10a sucks and holds the ingot 11 transported to the holding surface 10a by a negative pressure. Next, in the present example, the above-described microscope camera unit or the like is used to dispose the primary orientation flat 13 substantially in parallel with the X-axis.

The following laser beam irradiating step S20 includes a first processing feed S21, an indexing feed necessity determination S22, a first indexing feed S23, a second processing feed S24, an indexing feed necessity determination S25, and a second indexing feed S26.

FIG. 6 is a plan view of the ingot 11, the plan view illustrating the first processing feed S21, the first indexing feed S23, the second processing feed S24, and the second indexing feed S26. Incidentally, in FIG. 6, movement trajectories of the condensing point P of the laser beam L at times of processing feed and movement trajectories of the condensing point P of the laser beam L at times of indexing feed are indicated by broken lines.

In addition, in FIG. 6, some of a plurality of measurement target regions 11h in each of which the measurement of the electric resistance or the electric resistivity is performed are illustratively indicated by broken lines. Either of the electric resistance and the electric resistivity may be measured in the measurement target regions 11h. However, one of the electric resistance and the electric resistivity is consistently measured in the laser beam irradiating step S20.

The measurement target regions 11h are, for example, circular regions having a diameter of approximately 5.0 mm to 10 mm. Intervals between the centers of the measurement target regions 11h in the X-axis direction are 10 mm, for example. However, the intervals between the centers of the measurement target regions 11h are not limited to the present example.

When the ingot 11 is processed by the laser beam L, first, the chuck table 10 and the condenser 36 are moved relative to each other such that the first measurement head 44 precedes the condenser 36 in the processing feed direction (−X direction) (first processing feed S21).

At this time, the controller 60 measures the electric resistance or the electric resistivity of measurement target regions 11h of the ingot 11 by using the first measurement head 44, and maintains or changes conditions for the laser processing of the ingot 11 by the laser beam L to be applied to the measurement target regions 11h in real time according to the electric resistance or the electric resistivity of the measurement target regions 11h.

Hence, the controller 60 can perform, temporally in parallel with each other, the measurement of the electric resistance or the electric resistivity of each of the plurality of measurement target regions 11h discretely arranged along the movement trajectory of the condensing point P of the laser beam L and the laser processing on the ingot 11 according to the electric resistance or the electric resistivity.

That is, an investigation for the laser processing conditions and the laser processing reflecting a result of the investigation can be performed in one processing feed operation. It is therefore possible to reduce the number of man-hours as compared with a case of starting the laser processing after ending the measurement of the electric resistance or the electric resistivity in regions corresponding to the movement trajectory of the condensing point P of the laser beam L on the one surface 11a (that is, an exposed surface) of the ingot 11. That is, the throughput of the laser processing can be improved.

In the first processing feed S21 for a first time illustrated in FIG. 6, though the electric resistance or the electric resistivity of each of the measurement target regions 11h is measured, the laser processing conditions are maintained without being changed because the laser beam L is applied to the non-facet region 11g at all times.

A separating layer 11i is thereby formed within the ingot 11. The separating layer 11i is a region having a reduced mechanical strength as compared with a region not irradiated with the laser beam L. The separating layer 11i includes a modified region (not illustrated) in which crystallinity is changed from monocrystalline to amorphous, polycrystalline, or the like due to multiphoton absorption and cracks (not illustrated) extending from the modified region.

At a time of an end of the first processing feed S21, the condensing point P has not yet reached an end portion in the indexing feed direction (−Y direction) (YES in S22). Thus, next, the chuck table 10 and the condenser 36 are moved relative to each other in the indexing feed direction by a predetermined distance (first indexing feed S23).

Incidentally, the laser processing is ended when the condensing point P has reached the end portion in the indexing feed direction (for example, a position less than 100 μm from an outer circumferential edge in the −Y direction) (NO in S22 (S25)).

After the first indexing feed S23, the chuck table 10 and the condenser 36 are next moved relative to each other such that the second measurement head 54 precedes the condenser 36 in the processing feed direction (+X direction) (second processing feed S24).

At this time, the controller 60 measures the electric resistance or the electric resistivity of measurement target regions 11h of the ingot 11 by using the second measurement head 54, and maintains or changes the conditions for the laser processing of the ingot 11 by the laser beam L to be applied to the measurement target regions 11h in real time according to the electric resistance or the electric resistivity of the measurement target regions 11h.

In the second processing feed S24 for a first time illustrated in FIG. 6, though the electric resistance or the electric resistivity of each of the measurement target regions 11h is measured, the laser processing conditions are maintained without being changed because the laser beam L is applied to the non-facet region 11g at all times. A separating layer 11i is thereby formed within the ingot 11.

At a time of an end of the second processing feed S24, the condensing point P has not yet reached the end portion in the indexing feed direction (YES in S25). Thus, next, the chuck table 10 and the condenser 36 are moved relative to each other in the indexing feed direction by a predetermined distance (second indexing feed S26). When the condensing point P has reached the end portion in the indexing feed direction (NO in S26), on the other hand, the laser processing is ended.

In the example illustrated in FIG. 6, the first processing feed S21 is performed again after the second indexing feed S26. Thus, the controller 60 moves the chuck table 10 and the condenser 36 relative to each other so as to repeat the first processing feed S21, the first indexing feed S23, the second processing feed S24, and the second indexing feed S26 in order.

In the first processing feed S21 for a third time illustrated in FIG. 6, the measurement and the laser processing are performed on a straight line where the non-facet region 11g and the facet region 11f are mixed with each other. Thus, the laser processing conditions are changed according to the electric resistivity or the like of each of the measurement target regions 11h.

States of the first processing feed S21 for the third time are schematically illustrated in FIGS. 7A to 7C. Incidentally, in FIGS. 7A to 7C, the facet region 11f and the non-facet region 11g are hatched differently for the convenience of description.

In addition, as the chuck table 10 and the ingot 11 move in the +X direction (see a left arrow in FIG. 7A and the like), the condenser 36, the first measurement head 44, and the second measurement head 54 move in the −X direction. In this case, the processing feed direction is the −X direction.

FIG. 7A is a schematic diagram illustrating the measurement of the electric resistivity and the laser processing at time t₁. At time t₁, the first measurement head 44 measures the electric resistivity of the non-facet region 11g, and the condenser 36 irradiates the non-facet region 11g located in the +X direction with respect to the first measurement head 44 with the laser beam L.

Incidentally, the laser processing conditions in the non-facet region 11g at time t₁ are maintained without being changed from predetermined laser processing conditions according to the electric resistivity of the non-facet region 11g measured immediately previously via the first measurement head 44.

FIG. 7B is a schematic diagram illustrating the measurement of the electric resistivity and the laser processing at time t₂ after time t₁. At time t₂, the first measurement head 44 measures the electric resistivity of a measurement target region 11h_{X1} in the facet region 11f, and the condenser 36 irradiates the non-facet region 11g located in the +X direction with respect to the first measurement head 44 with the laser beam L.

The laser processing conditions in the non-facet region 11g at time t₂ are also maintained without being changed from the predetermined laser processing conditions according to the electric resistivity of the non-facet region 11g measured immediately previously via the first measurement head 44.

FIG. 7C is a schematic diagram illustrating the measurement of the electric resistivity and the laser processing at time t₃ after time t₂. At time t₃, the first measurement head 44 measures the electric resistivity of a measurement target region 11h_{X2} different from that at time t₂ in the facet region 11f, and the condenser 36 irradiates the measurement target region 11h_{X1} in the facet region 11f with the laser beam L.

The laser processing conditions in the facet region 11f at time t₃ are changed from the predetermined laser processing conditions according to the electric resistivity of the measurement target region 11h_{X1} in the facet region 11f, which electric resistivity has been measured immediately previously via the first measurement head 44.

In the facet region 11f having a relatively high impurity concentration, the absorptivity of the laser beam L in the ingot 11 is high (that is, the transmissivity of the laser beam L is low) as compared with the non-facet region 11g having a relatively low impurity concentration. Accordingly, when the facet region 11f is laser-processed, the controller 60 changes one or more of the following (a) to (d).
(a) Power of the laser beam L
(b) Defocus amount (that is, the height position of the condensing point P in the Z-axis direction)
(c) Repetition frequency of the laser beam L and/or the relative processing feed speed of the condensing point P and the ingot 11
(d) Number of times of processing-feeding the laser beam L on a same movement path of the condensing point P (that is, the number of passes)

For example, in the facet region 11f, the energy density of the laser beam L at a depth position at which the separating layers 11i are formed can be increased by increasing (a) the power of the laser beam L as compared with the non-facet region 11g. The separating layers 11i can be thereby formed at substantially the same depth position from the one surface 11a.

In addition, for example, in the facet region 11f, the energy density of the laser beam L and the mutual overlap area of condensing points (that is, an overlap ratio) at a depth position at which the separating layers 11i are formed can be increased by bringing (b) the height position of the condensing point P in the Z-axis direction above the one surface 11a close to the one surface 11a as compared with the non-facet region 11g. The separating layers 11i can be thereby formed at substantially the same depth position from the one surface 11a in the facet region 11f and the non-facet region 11g.

In addition, for example, in the facet region 11f, the pitch of the condensing points P can be narrowed by raising (c) the repetition frequency of the laser beam L as compared with the non-facet region 11g. The energy density of the laser beam L, the overlap ratio, and the like can be thereby increased.

Consequently, the separating layers 11i can be formed at substantially the same depth position from the one surface 11a in the facet region 11f and the non-facet region 11g. Incidentally, the repetition frequency is raised by, for example, stopping the thinning out one or more pulses, the thinning out being performed by the optical modulator 40.

In addition, for example, in the facet region 11f, the pitch of the condensing points P can be narrowed by decreasing (c) the processing feed speed as compared with the non-facet region 11g. The overlap ratio and the like of the laser beam L can be thereby increased.

Consequently, the separating layers 11i can be formed at substantially the same depth position from the one surface 11a in the facet region 11f and the non-facet region 11g. Incidentally, to change the processing feed speed, it suffices to change the output of the motor 30, and thereby change the movement speed of the moving table 26 by the processing feed unit 22.

In addition, for example, in the facet region 11f, the laser processing can be performed on the facet region 11f a plurality of times by increasing (d) the number of passes as compared with the non-facet region 11g. As a result, the separating layers 11i can be formed at substantially the same depth position from the one surface 11a.

Incidentally, when the laser processing is performed on the non-facet region 11g after the laser processing of the facet region 11f, the laser processing conditions are restored to the original laser processing conditions. In the second processing feed S24 after the first processing feed S21, the laser processing is similarly performed by using the condenser 36 and the second measurement head 54 preceding the condenser 36 in the processing feed direction.

The controller 60 in the present embodiment thus measures the electric resistance or the electric resistivity of the measurement target regions 11h by using one of the first measurement head 44 and the second measurement head 54 that precedes the condenser 36 in the processing feed direction at a time of the laser processing and maintains or changes the conditions for the laser processing of the ingot 11 by the laser beam L to be applied to the measurement target regions 11h according to the electric resistance or the electric resistivity of the measurement target regions 11h.

It is therefore possible to reduce the number of man-hours as compared with a case of starting the laser processing after ending the measurement of the electric resistance or the electric resistivity in regions corresponding to the movement trajectory of the condensing point P of the laser beam L on the one surface 11a of the ingot 11. That is, the throughput of the laser processing can be improved.

In a case where the power and/or the repetition frequency is/are to be changed among the laser processing conditions in the present embodiment, the optical modulator 40 can change the laser processing conditions, and thus increase response speed as compared with the attenuator that physically rotates the half-wave plate. It is therefore possible to make a change in the laser processing conditions sufficiently follow the processing feed speed.

The laser processing conditions in the first processing feed S21 and the second processing feed S24 (in a case of changing the power of the laser beam L) are illustrated in the following. Incidentally, an average power is equal to a product of pulse energy and repetition frequency. Hence, the pulse energy under the following laser processing conditions corresponds to 20 μJ or more and 180 μJ or less.
Wavelength: 1064 nm
Average power: 0.6 W or more and 5.4 W or less
Repetition frequency: 30 kHz
Pulse width: 3 ns
Processing feed speed: 165 mm/s
Defocus amount: 188 μm (distance in the +Z direction with respect to the one surface 11a)
Depth of separating layers: 500 μm (distance in the −Z direction with respect to the one surface 11a)

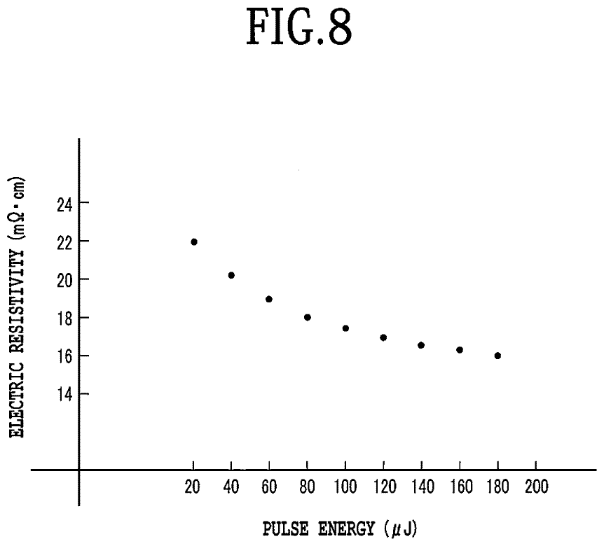

FIG. 8 is a graph illustrating the electric resistivity of the ingot 11 and the pulse energy of the laser beam L adjusted according to the electric resistivity. In the facet region 11f and the non-facet region 11g, the electric resistivity changes in a range equal to or more than 16 mΩ·cm and equal to or less than 22 mΩ·cm, for example.

In addition, within the facet region 11f, the electric resistivity is low as compared with the non-facet region 11g, but the electric resistivity can change in a range equal to or more than 16 mΩ·cm and equal to or less than 22 mΩ·cm.

Accordingly, the controller 60 stores correspondence relation between the electric resistivity (mΩ·cm) and the pulse energy (μJ) illustrated in FIG. 8 in the auxiliary storage apparatus in advance, and maintains or changes the pulse energy (that is, the average power) according to the electric resistivity obtained via the first measurement head 44 or the second measurement head 54.

Of course, as described above, (b) the defocus amount, (c) the repetition frequency of the laser beam L and/or the processing feed speed, and (d) the number of passes may be changed in place of the pulse energy (that is, the average power).

It is to be noted that (a) the power, (b) the defocus amount, and (c) the repetition frequency and/or the processing feed speed are not limited to being changed in a binary manner between the facet region 11f and the non-facet region 11g.

In each of the facet region 11f and the non-facet region 11g, at least one selected from the group consisting of (a) the power, (b) the defocus amount, and (c) the repetition frequency and/or the processing feed speed may be changed in a linear manner, or may be changed in a stepwise manner.

Without the laser processing conditions being changed at all in the non-facet region 11g, at least one selected from the group consisting of (a) the power, (b) the defocus amount, and (c) the repetition frequency and/or the processing feed speed may be changed in a linear manner or in a stepwise manner within only the facet region 11f.

### (First Modification)

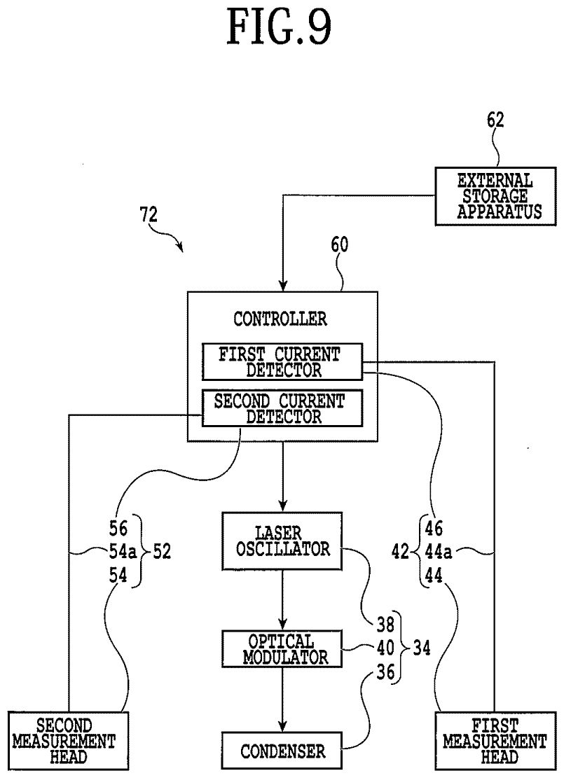

A first modification of the first embodiment will next be described with reference to FIG. 9. FIG. 9 is a block diagram illustrating principal parts of a laser processing apparatus 72 in the first modification. In the first modification, the first current detector 46 and the second current detector 56 are formed integrally with the controller 60.

For example, the processor 60a and the memory 60b constituting the controller 60 and the first current detector 46 and the second current detector 56 are housed within a same casing (not illustrated), or are fixed to a same motherboard.

### Second Embodiment

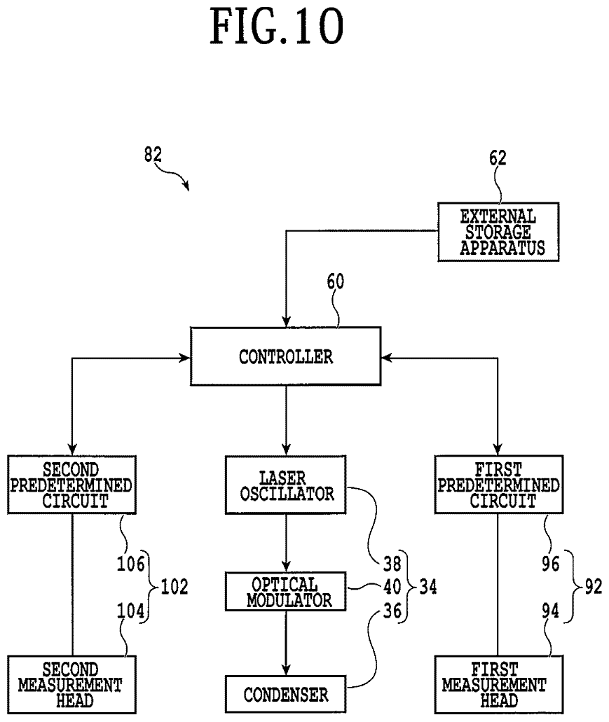

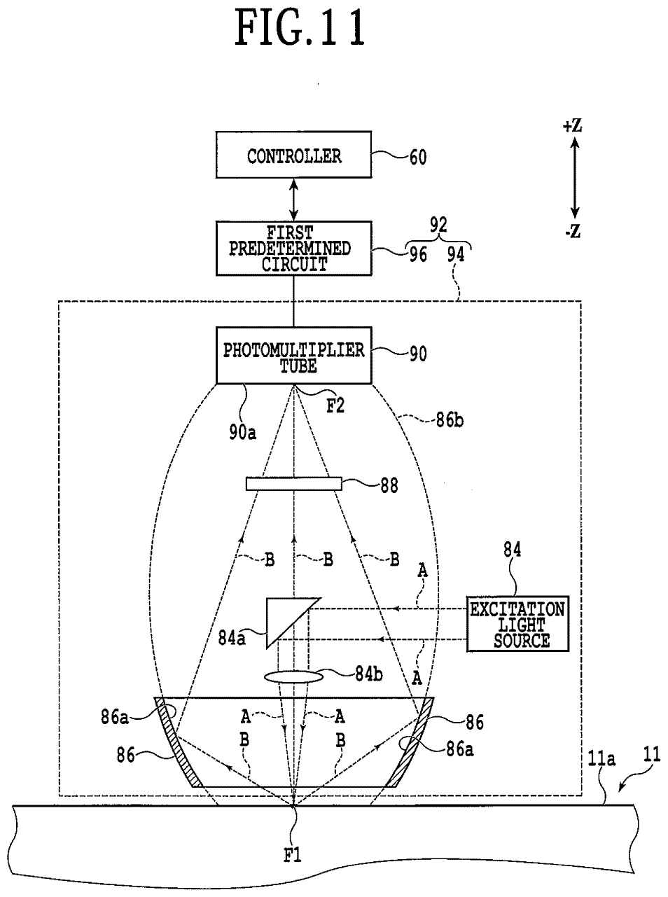

A laser processing apparatus 82 according to a second embodiment will next be described with reference to FIGS. 10 to 11. Incidentally, the same constituent elements as in the laser processing apparatus 2 according to the first embodiment will be described by using the same reference numerals.

The laser processing apparatus 82 according to the second embodiment includes a first fluorescence measuring apparatus 92 and a second fluorescence measuring apparatus 102 in place of the first resistance measuring apparatus 42 and the second resistance measuring apparatus 52. FIG. 10 is a block diagram illustrating principal parts of the laser processing apparatus 82 in the second embodiment.

The first fluorescence measuring apparatus 92 includes a first measurement head 94 at a position that is on the distal end portion of the support arm 8a and which is adjacent in the −X direction to the condenser 36. That is, the first measurement head 94 has a fixed spatial relative position with respect to the condenser 36.

However, the first measurement head 94 is configured to be relatively movable with respect to the chuck table 10 along the processing feed direction. That is, when the chuck table 10 and the condenser 36 are moved relative to each other along the processing feed direction by using the processing feed unit 22, the first measurement head 94 relatively moves with respect to the chuck table 10 along the processing feed direction together with the condenser 36.

In addition, the first measurement head 94 is configured to be relatively movable with respect to the chuck table 10 along the indexing feed direction. That is, when the chuck table 10 and the condenser 36 are moved relative to each other along the indexing feed direction by using the indexing feed unit 12, the first measurement head 94 relatively moves with respect to the chuck table 10 along the indexing feed direction together with the condenser 36.

A second measurement head 104 that constitutes the second fluorescence measuring apparatus 102 is fixed at a position that is on the distal end portion of the support arm 8a and which is adjacent in the +X direction to the condenser 36. That is, the second measurement head 104 also has a fixed spatial relative position with respect to the condenser 36, and the first measurement head 94 and the second measurement head 104 are arranged so as to sandwich the condenser 36 in the processing feed direction.

However, the second measurement head 104 is configured to be relatively movable with respect to the chuck table 10 along the processing feed direction. That is, when the chuck table 10 and the condenser 36 are moved relative to each other along the processing feed direction by using the processing feed unit 22, the second measurement head 104 also relatively moves with respect to the chuck table 10 along the processing feed direction together with the condenser 36 in a similar manner to the first measurement head 94.

In addition, the second measurement head 104 is configured to be relatively movable with respect to the chuck table 10 along the indexing feed direction. That is, when the chuck table 10 and the condenser 36 are moved relative to each other along the indexing feed direction by using the indexing feed unit 12, the second measurement head 104 relatively moves with respect to the chuck table 10 along the indexing feed direction together with the condenser 36.

The first fluorescence measuring apparatus 92 includes the first measurement head 94. The second fluorescence measuring apparatus 102 includes the second measurement head 104. The first measurement head 94 and the second measurement head 104 irradiate a local region (for example, a circular region having a diameter of approximately 200 μm to 500 μm) of the one surface 11a with excitation light A (see FIG. 11) including ultraviolet rays (for example, 365 nm) to be absorbed by the ingot 11.

FIG. 11 is a partially sectional side view illustrating the first measurement head 94 in the second embodiment. Incidentally, in FIG. 11, a part of constituent elements of the first measurement head 94 are represented by functional blocks.

The first measurement head 94 includes an excitation light source 84. The excitation light source 84 includes a GaN-based light emitting diode (LED), for example. The excitation light A having a predetermined power is emitted from the excitation light source 84.

A prism mirror 84a is provided on a side of the excitation light source 84. The excitation light A emitted from the excitation light source 84 is reflected downward by the prism mirror 84a. A condensing lens 84b is provided below the prism mirror 84a.

The condensing lens 84b condenses the excitation light A reflected by the prism mirror 84a to one predetermined point. In the present embodiment, the one predetermined point corresponds to one point in the one surface 11a of the ingot 11. An elliptic mirror 86 is provided below the prism mirror 84a and the condensing lens 84b so as to surround the region irradiated with the excitation light A in the one surface 11a as viewed in plan.

The elliptic mirror 86 has a reflecting surface 86a as an inner surface thereof. The reflecting surface 86a corresponds to a part of an external surface 86b of a spheroid. The major axis of the spheroid is disposed along the Z-axis. The minor axis of the spheroid is disposed along the XY plane. The elliptic mirror 86 has two focuses F1 and F2. The position of the focus of the condensing lens 84b substantially coincides with the position of the focus F1.

When the excitation light A is condensed at the focus F1, fluorescence B occurs from the one surface 11a of the ingot 11 that absorbs the excitation light A. The fluorescence B emitted from the one surface 11a is reflected by the reflecting surface 86a of the elliptic mirror 86, and is then condensed at the focus F2 via a filter 88.

The filter 88 is an optical filter that blocks light of wavelengths less than 750 nm, and transmits light of wavelengths equal to or more than 750 nm. A photocathode 90a of a photomultiplier tube (that is, an optical sensor) 90 is disposed at the focus F2. The photomultiplier tube 90 further includes an entrance window, a plurality of dynodes, an anode (neither is illustrated), and the like.

A first predetermined circuit 96 including a divider circuit and the like is electrically connected to the photomultiplier tube 90. When the photomultiplier tube 90 receives light having a wavelength of 1500 nm or less, an electric signal indicating the number of photons of the received light is transmitted to the controller 60 via the first predetermined circuit 96.

Thus, the controller 60 can grasp the number of photons of the fluorescence B measured via the first measurement head 94 without contact with the ingot 11 (that is, in a noncontact manner). The configuration of the second measurement head 104 is substantially the same as that of the first measurement head 94.

The second fluorescence measuring apparatus 102 includes the second measurement head 104 and a second predetermined circuit 106 corresponding to the first predetermined circuit 96 (see FIG. 10). The controller 60 can also grasp the number of photons of the fluorescence B by using the second measurement head 104.

The number of photons of the fluorescence B has a negative correlation to impurity concentration in the ingot 11. Specifically, the higher the impurity concentration is, the smaller the number of photons of the fluorescence B tends to be. In an example, the number of photons measured in the facet region 11f is 1000 cps (count per second) or more and 4000 cps or less, and the number of photons measured in the non-facet region 11g is 5000 cps or more.

Incidentally, the elliptic mirror 86 may be omitted, and a dichroic mirror (not illustrated) may be provided in place of the prism mirror 84a. The dichroic mirror has a function of reflecting the excitation light A in an ultraviolet band but transmitting the fluorescence B in an infrared band.

In a case where the elliptic mirror 86 is omitted, and a dichroic mirror is provided in place of the prism mirror 84a, the excitation light A from the excitation light source 84 is first reflected by the dichroic mirror, and is then condensed at the one surface 11a of the ingot 11 via the condensing lens 84b.

The fluorescence B emitted from the one surface 11a when the ingot 11 absorbs the excitation light A sequentially passes through the condensing lens 84b, the dichroic mirror, and the filter 88, and reaches the photomultiplier tube 90. Also in this manner, the controller 60 can grasp the number of photons of the fluorescence B measured via the first measurement head 94.

In the second embodiment, when the ingot 11 is irradiated with the laser beam L, the number of photons of the fluorescence B from the measurement target regions 11h is measured by using one of the first measurement head 94 and the second measurement head 104 that precedes the condenser 36 in the processing feed direction.

Then, the conditions for the laser processing of the ingot 11 by the laser beam L to be applied to the measurement target regions 11h are maintained or changed according to the number of photons of the fluorescence B from the measurement target regions 11h. That is, the measurement of the number of photons of the fluorescence B in the ingot 11 and the laser processing of the ingot 11 according to the number of photons of the fluorescence B can be performed temporally in parallel with each other.

That is, an investigation for the laser processing conditions and the laser processing reflecting a result of the investigation can be performed in one processing feed operation. Hence, it is possible to reduce the number of man-hours as compared with a case of starting the laser processing after ending the measurement of the number of photons of the fluorescence B in regions corresponding to the movement trajectory of the condensing point P on the one surface 11a (that is, an exposed surface) of the ingot 11. That is, the throughput of the laser processing can be improved.

Also in the second embodiment, the laser processing conditions may be changed by changing at least one selected from the group consisting of (a) the power, (b) the defocus amount, (c) the repetition frequency and/or the processing feed speed, and (d) the number of passes.

The laser processing conditions may be changed in a binary manner in the facet region 11f and the non-facet region 11g, the laser processing conditions may be changed in a linear manner or a stepwise manner in both of the facet region 11f and the non-facet region 11g, or the laser processing conditions may be changed in a linear manner or a stepwise manner within only the facet region 11f without the laser processing conditions being changed at all in the non-facet region 11g.

Also in a case where the above-described laser processing method is performed by using the laser processing apparatus 82, steps are performed in the order of the holding step S10 and the laser beam irradiating step S20. The laser beam irradiating step S20 includes the first processing feed S21, the indexing feed necessity determination S22, the first indexing feed S23, the second processing feed S24, the indexing feed necessity determination S25, and the second indexing feed S26.

Before the laser processing, first, when a distribution of the number of photons of the fluorescence B within the plane of the one surface 11a is measured, the condensing point of the excitation light A is generally moved helically on the one surface 11a in order to measure a wide range rapidly (generally-called helical scanning is performed) (see the above-described Japanese Patent Laid-Open No. 2022-127088).

On the other hand, in the present embodiment, the movement path of the condensing point of the excitation light A is substantially in a same linear shape as the movement path of the condensing point P of the laser beam L, and therefore the helical scanning is not performed as long as the ingot 11 is laser-processed with the laser beam L by the first processing feed S21 and the second processing feed S24.

The predetermined program stored in the auxiliary storage apparatus of the controller 60 includes a program for making the controller 60 perform the laser beam irradiating step S20. However, alternatively, this program may be stored in the external storage apparatus 62, and executed by inputting the program read via a reading apparatus to the processor 60a.

### (Second Modification)

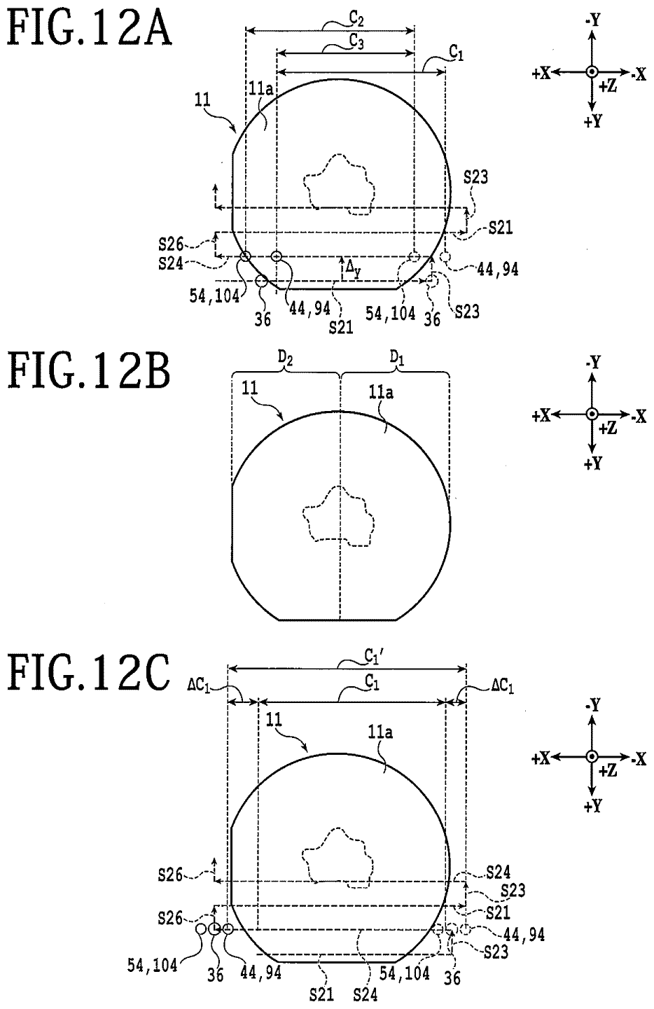

A second modification of the first and second embodiments will next be described with reference to FIGS. 12A to 12C. As illustrated in FIG. 12A, in the second modification, the first measurement head 44 and the second measurement head 54 are arranged so as to precede the condenser 36 by a predetermined distance Δ_{y} in the indexing feed direction.

The first measurement head 94 and the second measurement head 104 may of course be arranged so as to precede the condenser 36 by the predetermined distance Δ_{y} in the indexing feed direction. A notation of the first measurement head 44 (94) and the second measurement head 54 (104) is therefore used in the second modification.

Incidentally, while reference numerals corresponding to the measurement heads are not provided with parentheses for convenience in FIGS. 12A to 12C, a combination of the condenser 36, the first measurement head 44, and the second measurement head 54 may be used, or a combination of the condenser 36, the first measurement head 94, and the second measurement head 104 may be used.

FIG. 12A is a plan view illustrating positional relation between the condenser 36, the first measurement head 44 (94), and the second measurement head 54 (104) in the second modification. The predetermined distance Δ_{y} is equal to a natural number multiple of an indexing feed amount in the laser beam irradiating step S20. The predetermined distance Δ_{y} is 1.0 mm, for example.

Also in the laser beam irradiating step S20 of the second modification, as in the foregoing embodiment, the first processing feed S21, the first indexing feed S23, the second processing feed S24, and the second indexing feed S26 are sequentially repeated. However, in the first processing feed S21 for a first time, the laser processing is not performed, but only the measurement of the electric resistance or the electric resistivity (or the number of photons of the fluorescence B) in measurement target regions 11h (see FIG. 6) is performed.

Then, in the second processing feed S24 for a first time, the laser processing is performed while the laser processing conditions for the irradiation of the measurement target regions 11h are maintained or changed according to the electric resistance or the electric resistivity (or the number of photons of the fluorescence B) measured in the first processing feed S21 for the first time, and the electric resistance or the electric resistivity (or the number of photons of the fluorescence B) in measurement target regions 11h different from those of the first processing feed S21 for the first time is measured.

Thus, the second modification simultaneously performs measurement using the first measurement head 44 (94) and the second measurement head 54 (104) in a processing target line preceding in the indexing feed direction and laser processing under the laser processing conditions reflecting an immediately preceding measurement result of the first measurement head 44 (94) and the second measurement head 54 (104) in a processing target line succeeding in the indexing feed direction.

In FIG. 12A, a region C₁ represents a movement range of the first measurement head 44 (94) in the second processing feed S24 for the first time. Similarly, a region C₂ represents a movement range of the second measurement head 54 (104) in the second processing feed S24 for the first time. In addition, a region C₃ represents a range passed by both of the first measurement head 44 (94) and the second measurement head 54 (104) in the second processing feed S24 for the first time.

The second modification performs the measurement of the electric resistance or the electric resistivity (or the number of photons of the fluorescence B) by using both of the first measurement head 44 (94) and the second measurement head 54 (104) rather than one of the first measurement head 44 (94) and the second measurement head 54 (104) that precedes in the processing feed direction.

FIG. 12B is a diagram illustrating which of results of measurements using the first measurement head 44 (94) and the second measurement head 54 (104) the controller 60 stores. The controller 60 stores the measurement result obtained by using the first measurement head 44 (94) for a left half region D₁ of the one surface 11a, and stores the measurement result obtained by using the second measurement head 54 (104) for a right half region D₂ of the one surface 11a.

FIG. 12C is a diagram illustrating a movement range of the first measurement head 44 (94) in the foregoing embodiment in comparison with the second modification, and illustrates advantages of the second modification over the foregoing embodiment. A region C₁ illustrated in FIG. 12C is the same as the region C₁ illustrated in FIG. 12A.

The movement range of the first measurement head 44 (94) in the foregoing embodiment is a region C₁′, which is wider than the region C₁. In the foregoing embodiment, the first measurement head 44 (94) precedes the condenser 36 in the first processing feed S21 for the first time, while the second measurement head 54 (104) precedes the condenser 36 in the following second processing feed S24 for the first time.

Therefore, in the first processing feed S21, the foregoing embodiment needs to perform processing feed until the second measurement head 54 (104) is located more outward in the X-axis direction than a start position of the second processing feed S24 immediately succeeding the first processing feed S21.

On the other hand, the second modification uses both of the first measurement head 44 (94) and the second measurement head 54 (104). Thus, even when a processing feed amount is shortened, the measurement of the electric resistance or the electric resistivity (or the number of photons of the fluorescence B) can be performed on an entire processing target line where the second processing feed S24 for the first time is performed.

As a result, the movement range of the first measurement head 44 (94) becomes shorter by a difference ΔC₁ (=C₁′−C₁). The shortening of the movement range is synonymous with the shortening of the processing feed amount. The shortening of the processing feed amount can shorten a time taken for the laser processing, so that production efficiency of the laser processing can be increased.

Besides, structures, methods, and the like according to the foregoing embodiments can be modified and implemented as appropriate without departing from the objective scope of the present invention. The conductivity type of the ingot 11 is not particularly limited. The ingot 11 may be of an n-type, or may be of a p-type.

In addition, the ingot 11 is not limited to SiC or the like. The above-described laser processing method in which nonuniformity of impurity concentration is taken into consideration can be applied when separating layers 11i are formed in a workpiece such as a silicon (Si) ingot.

Incidentally, in each of the embodiments, after the laser beam irradiating step S20, a wafer (not illustrated) is peeled off the ingot 11 with the separating layers 11i as a boundary. After the peeling, another wafer can be manufactured from the ingot 11 when a peeled surface of the ingot 11 is subjected to grinding, polishing, and the like, and thereafter the holding step S10 and the laser beam irradiating step S20 are performed again.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing apparatus for processing a workpiece by a laser beam, the laser processing apparatus comprising:
a holding unit configured to hold the workpiece;
a laser beam irradiating unit including a laser oscillator configured to emit the laser beam and a condenser including a condensing lens configured to condense the laser beam emitted from the laser oscillator;
a processing feed unit including a first motor and configured to move the holding unit and the condenser relative to each other along a processing feed direction;
a first resistance measuring apparatus including a first measurement head having a fixed relative position with respect to the condenser and configured to be relatively movable by the processing feed unit along the processing feed direction with respect to the holding unit together with the condenser, the first resistance measuring apparatus being configured to measure electric resistance or electric resistivity of the workpiece via the first measurement head; and
a controller including a processor and a memory and configured to control the laser beam irradiating unit and the processing feed unit,
the controller being configured to, when irradiating the workpiece with the laser beam while moving the holding unit and the condenser relative to each other along the processing feed direction, measure the electric resistance or the electric resistivity of a measurement target region of the workpiece by using the first measurement head and maintain or change a condition for processing the workpiece by the laser beam to be applied to the measurement target region according to the electric resistance or the electric resistivity of the measurement target region.

2. The laser processing apparatus according to claim 1, further comprising:
a second resistance measuring apparatus including a second measurement head having a fixed relative position with respect to the condenser and the first measurement head and configured to be relatively movable by the processing feed unit along the processing feed direction with respect to the holding unit together with the condenser, the second resistance measuring apparatus being configured to measure the electric resistance or the electric resistivity of the workpiece via the second measurement head, wherein
the first measurement head and the second measurement head are arranged so as to sandwich the condenser in the processing feed direction.

3. The laser processing apparatus according to claim 2, wherein,
when irradiating the workpiece with the laser beam while moving the holding unit and the condenser relative to each other along the processing feed direction, the controller measures the electric resistance or the electric resistivity by using one of the first measurement head and the second measurement head that precedes the condenser in the processing feed direction.

4. The laser processing apparatus according to claim 2, further comprising:
an indexing feed unit including a second motor and configured to move the holding unit and the condenser relative to each other along an indexing feed direction intersecting the processing feed direction, wherein,
when processing the workpiece by the laser beam, the controller moves the holding unit and the condenser relative to each other so as to sequentially repeat
a first processing feed configured to move the holding unit and the condenser relative to each other such that the first measurement head precedes the condenser in the processing feed direction,
a first indexing feed configured to move the holding unit and the condenser relative to each other in the indexing feed direction,
a second processing feed configured to move the holding unit and the condenser relative to each other such that the second measurement head precedes the condenser in the processing feed direction, and
a second indexing feed configured to move the holding unit and the condenser relative to each other in the indexing feed direction.

5. A laser processing method for processing a workpiece by a laser beam, the laser processing method comprising:
holding the workpiece by a holding unit; and
when irradiating the workpiece with the laser beam while moving the holding unit and a condenser relative to each other along a processing feed direction, measuring electric resistance or electric resistivity of a measurement target region of the workpiece by using a first measurement head having a fixed relative position with respect to the condenser, and maintaining or changing a condition for processing the workpiece by the laser beam to be applied to the measurement target region according to the electric resistance or the electric resistivity of the measurement target region.

6. A non-transitory computer-readable medium storing a program for causing a computer mounted in a laser processing apparatus to execute processing comprising:
when irradiating a workpiece with a laser beam while moving a holding unit holding the workpiece and a condenser relative to each other along a processing feed direction, measuring electric resistance or electric resistivity of a measurement target region of the workpiece by using a first measurement head having a fixed relative position with respect to the condenser, and maintaining or changing a condition for processing the workpiece by the laser beam to be applied to the measurement target region according to the electric resistance or the electric resistivity of the measurement target region

7. A laser processing apparatus for processing a workpiece by a laser beam, the laser processing apparatus comprising:
a holding unit configured to hold the workpiece;
a laser beam irradiating unit including a laser oscillator configured to emit the laser beam and a condenser including a condensing lens configured to condense the laser beam emitted from the laser oscillator;
a processing feed unit including a first motor and configured to move the holding unit and the condenser relative to each other along a processing feed direction;
a fluorescence measuring apparatus including a measurement head having a fixed relative position with respect to the condenser and configured to be relatively movable by the processing feed unit along the processing feed direction with respect to the holding unit together with the condenser, the measurement head including an excitation light source, a condensing lens configured to condense excitation light from the excitation light source to the workpiece, and an optical sensor configured to receive fluorescence emitted from the workpiece when the workpiece absorbs the excitation light; and
a controller including a processor and a memory and configured to control the laser beam irradiating unit and the processing feed unit,
the controller being configured to, when irradiating the workpiece with the laser beam while moving the holding unit and the condenser relative to each other along the processing feed direction, maintain or change a condition for processing the workpiece by the laser beam to be applied to a measurement target region of the workpiece according to the number of photons of the fluorescence from the measurement target region, the number being obtained by using the measurement head.
